(19) United States
(12) Patent Application Publication
(10) Pub. No.: US 2017/0373600 A1
(43) Pub. Date: Dec. 28, 2017

(54) MULTI-MODE SWITCHING POWER CONVERTER

(71) Applicant: Cirrus Logic International Semiconductor Ltd., Edinburgh (GB)

(72) Inventors: Xiangcheng WANG, Austin, TX (US); Eric J. KING, Dripping Springs, TX (US)

(73) Assignee: Cirrus Logic International Semiconductor Ltd., Edinburgh (GB)

(21) Appl. No.: 15/190,819

(22) Filed: Jun. 23, 2016

(51) Int. Cl. H02M 3/158; H04R 3/04; H02M 1/08

(52) U.S. Cl. CPC H02M 3/1582; H02M 1/08; H04R 3/04

(57) ABSTRACT

In accordance with embodiments of the present disclosure, a multi-mode switching power converter may include a power inductor, a first switch coupled between a first terminal of the power inductor and a first supply terminal having a first voltage, a second switch coupled between the first terminal of the power inductor and a second supply terminal having a second voltage, a full bridge comprising a plurality of switches and having an output for producing the output voltage comprising a first output terminal and a second output terminal, wherein a first input of the full bridge is coupled to a second terminal of the power inductor and a second input of the full bridge is coupled to one of the first supply terminal and the second supply terminal, and a capacitor coupled between the first output terminal and the second output terminal.

### FIELD OF DISCLOSURE

The present disclosure relates in general to circuits for audio devices, including without limitation personal audio devices such as wireless telephones and media players, and more specifically, to a switch mode amplifier including a reconfigurable switched mode converter for driving an audio transducer of an audio device.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones or one or more speakers. Such circuitry often includes a speaker driver including a power amplifier for driving an audio output signal to headphones or speakers.

One existing approach to driving an audio output signal is to employ a speaker driver, such as speaker driver 100 depicted in FIG. 1. Speaker driver 100 may include an envelope-tracking boost converter 102 (e.g., a Class H amplifier) followed by a full-bridge output stage 104 (e.g., a Class D amplifier) which effectively operates as another converter stage. Boost converter 102 may include a power inductor 105, switches 106, 108, and a capacitor 110 arranged as shown. Full-bridge output stage 104 may include switches 112, 114, 116, and 118, inductors 120 and 124, and capacitors 122 and 126 as shown.

Speaker drivers such as speaker driver 100 suffer from numerous disadvantages. One disadvantage is that due to switching in output stage 104, such a speaker driver 100 may give rise to large amounts of radiated electromagnetic radiation, which may cause interference with other electromagnetic signals. Such radiated electromagnetic interference may be mitigated by LC or resonant filters formed using inductor 120 and capacitor 122 and inductor 124 and capacitor 126. However, such LC filters are often quite large in size, and coupling capacitors 122 and 126 to the terminals of the output transducer may have a negative impact on the power efficiency of speaker driver 100. Another disadvantage is that boost converter 102 may operate at switching frequencies up to several megahertz, and full-bridge output stage may operate at switching frequencies up to several hundred kilohertz to generate an audio band frequency signal, which may result in high switching power loss. However, reducing switching frequency may reduce switching loss but may require increases in physical dimension sizes of boost inductor 105 and output inductive-capacitive filters (not shown). To further reduce common-mode electromagnetic interference of full-bridge output stage 104, a typical edge slew rate control may be applied to full-bridge output stage 104, causing even higher switching loss.

In addition, such architectures often do not handle large impulsive signals. To reduce power consumption, an output voltage V_{BST} generated by boost converter 102 may be varied in accordance with the output signal, such that output voltage V_{BST} may operate at lower voltage levels for lower output signal magnitudes. Thus, if a signal quickly increases, adequate time may not be present to increase voltage V_{BST}, thus leading to signal clipping unless a delay is placed in the signal path. However, adding a delay to a signal path may cause incompatibility with other types of audio circuits, such as adaptive noise cancellation circuits.

### SUMMARY

In accordance with the teachings of the present disclosure, one or more disadvantages and problems associated with existing approaches to driving an audio output signal to an audio transducer may be reduced or eliminated.

In accordance with embodiments of the present disclosure, a multi-mode switching power converter may include a power inductor, a first switch coupled between a first terminal of the power inductor and a first supply terminal having a first voltage, a second switch coupled between the first terminal of the power inductor and a second supply terminal having a second voltage, a full bridge comprising a plurality of switches and having an output for producing the output voltage comprising a first output terminal and a second output terminal, wherein a first input of the full bridge is coupled to a second terminal of the power inductor and a second input of the full bridge is coupled to one of the first supply terminal and the second supply terminal, and a capacitor coupled between the first output terminal and the second output terminal.

In accordance with these and other embodiments of the present disclosure, a method may include, in a multi-mode switching power converter comprising a power inductor, a first switch coupled between a first terminal of the power inductor and a first supply terminal having a first voltage, a second switch coupled between the first terminal of the power inductor and a second supply terminal having a second voltage, a full bridge comprising a plurality of switches and having an output for producing the output voltage comprising a first output terminal and a second output terminal, wherein a first input of the full bridge is coupled to a second terminal of the power inductor and a second input of the full bridge is coupled to one of the first supply terminal and the second supply terminal, and a capacitor coupled between the first output terminal and the second output terminal, sequentially operating the first switch, the second switch, and the plurality of switches in a plurality of switch configurations in accordance with a selected operational mode of the power converter, the selected operational mode selected from a plurality of operational modes.

In accordance with these and other embodiments of the present disclosure, a switching power stage for producing an output voltage to a load may include a multi-mode switching power converter and a controller. The multi-mode switching power converter may include a power inductor, a first switch coupled between a first terminal of the power inductor and a first supply terminal having a first voltage, a second switch coupled between the first terminal of the power inductor and a second supply terminal having a second voltage, a full bridge comprising a plurality of switches and having an output for producing the output voltage comprising a first output terminal and a second output terminal, wherein a first input of the full bridge is coupled to a second terminal of the power inductor and a second input of the full bridge is coupled to one of the first supply terminal and the second supply terminal, and a capacitor coupled between the first output terminal and the second output terminal. The controller may be configured to sequentially operate the first switch, the second switch, and the plurality of switches in a plurality of switch configurations in accordance with a selected operational mode of the power converter, the selected operational mode selected from a plurality of operational modes.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example speaker driver, as is known in the relevant art;

FIG. 2 illustrates an example personal audio device, in accordance with embodiments of the present disclosure;

FIG. 3 illustrates a block diagram of selected components of an example audio integrated circuit of a personal audio device, in accordance with embodiments of the present disclosure;

FIG. 4 illustrates a block and circuit diagram of selected components of an example switched mode amplifier, in accordance with embodiments of the present disclosure;

FIG. 5 illustrates a circuit diagram of selected components of an example power converter, in accordance with embodiments of the present disclosure;

FIG. 6 illustrates a switch timing table setting forth switch configurations of the power converter of FIG. 5 when operating in a buck mode, in accordance with embodiments of the present disclosure;

FIGS. 7A-7D illustrate equivalent circuit diagrams of selected components of the power converter of FIG. 5 operating in various phases of a buck mode in accordance with the switch timing table of FIG. 6, in accordance with embodiments of the present disclosure;

FIG. 8 illustrates a switch timing table setting forth switch configurations of the power converter of FIG. 5 when operating in a boost mode, in accordance with embodiments of the present disclosure;

FIGS. 9A-9D illustrate equivalent circuit diagrams of selected components of the power converter of FIG. 5 operating in various phases of a boost mode in accordance with the switch timing table of FIG. 8, in accordance with embodiments of the present disclosure;

FIG. 10 illustrates a switch timing table setting forth switch configurations of the power converter of FIG. 5 when operating in a differential buck-boost mode, in accordance with embodiments of the present disclosure;

FIGS. 11A-11C illustrate equivalent circuit diagrams of selected components of the power converter of FIG. 5 operating in various phases of a differential buck-boost in accordance with the switch timing table of FIG. 10, in accordance with embodiments of the present disclosure;

FIG. 12 illustrates a circuit diagram of selected components of another example power converter, in accordance with embodiments of the present disclosure;

FIG. 13 illustrates a circuit diagram of selected components of another example power converter, in accordance with embodiments of the present disclosure;

FIG. 14 illustrates a switch timing table setting forth switch configurations of the power converter of FIG. 13 when operating in a buck mode, in accordance with embodiments of the present disclosure;

FIGS. 15A-15D illustrate equivalent circuit diagrams of selected components of the power converter of FIG. 13 operating in various phases of a buck mode in accordance with the switch timing table of FIG. 14, in accordance with embodiments of the present disclosure;

FIG. 16 illustrates a table setting forth switch configurations of the power converter of FIG. 13 when operating in a boost mode, in accordance with embodiments of the present disclosure;

FIGS. 17A-17D illustrate equivalent circuit diagrams of selected components of the power converter of FIG. 13 operating in various phases of a boost mode, in accordance with embodiments of the present disclosure;

FIG. 18 illustrates a switch timing table setting forth switch configurations of the power converter of FIG. 13 when operating in a buck-boost mode, in accordance with embodiments of the present disclosure;

FIGS. 19A-19D illustrate equivalent circuit diagrams of selected components of the power converter of FIG. 13 operating in various phases of a buck-boost mode in accordance with the switch timing table of FIG. 18, in accordance with embodiments of the present disclosure;

FIG. 20 illustrates a circuit diagram of selected components of another example power converter, in accordance with embodiments of the present disclosure; and

FIG. 21 illustrates a circuit diagram of selected components of another example power converter, in accordance with embodiments of the present disclosure.

### DETAILED DESCRIPTION

FIG. 2 illustrates an example personal audio device 1, in accordance with embodiments of the present disclosure. FIG. 2 depicts personal audio device 1 coupled to a headset 3 in the form of a pair of earbud speakers 8A and 8B. Headset 3 depicted in FIG. 2 is merely an example, and it is understood that personal audio device 1 may be used in connection with a variety of audio transducers, including without limitation, headphones, earbuds, in-ear earphones, and external speakers. A plug 4 may provide for connection of headset 3 to an electrical terminal of personal audio device 1. Personal audio device 1 may provide a display to a user and receive user input using a touch screen 2, or alternatively, a standard liquid crystal display (LCD) may be combined with various buttons, sliders, and/or dials disposed on the face and/or sides of personal audio device 1. As also shown in FIG. 2, personal audio device 1 may include an audio integrated circuit (IC) 9 for generating an analog audio signal for transmission to headset 3 and/or another audio transducer.

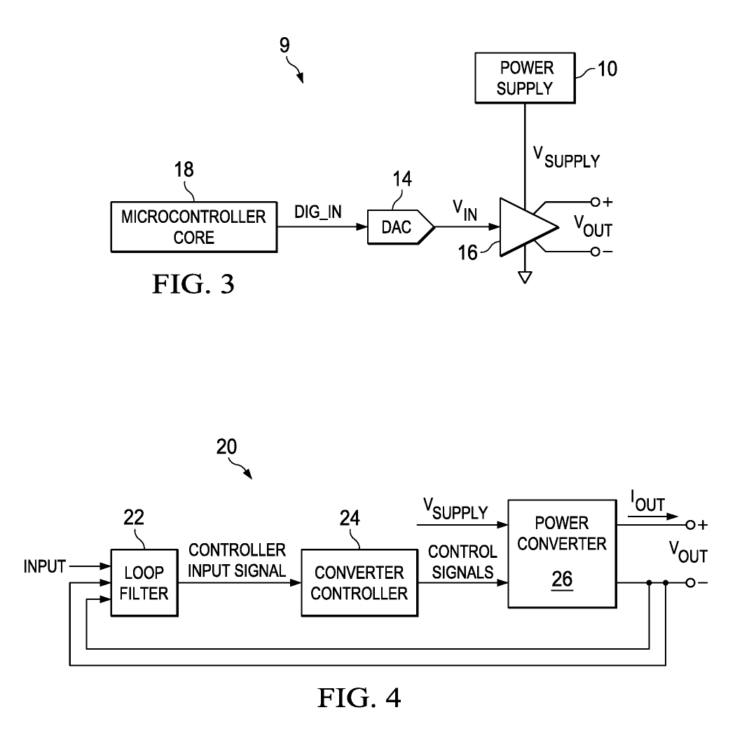

FIG. 3 illustrates a block diagram of selected components of an example audio IC 9 of a personal audio device, in accordance with embodiments of the present disclosure. As shown in FIG. 3, a microcontroller core 18 may supply a digital audio input signal DIG_IN to a digital-to-analog converter (DAC) 14, which may convert the digital audio input signal to an analog signal Y_{IN}. DAC 14 may supply analog signal Y_{IN} to an amplifier 16 which may amplify or attenuate audio input signal Y_{IN} to provide an audio output signal V_{OUT}, which may operate a speaker, a headphone transducer, a line level signal output, and/or other suitable output. In some embodiments, DAC 14 may be an integral component of amplifier 16. A power supply 10 may provide the power supply rail inputs of amplifier 16. In some embodiments, power supply 10 may comprise a battery. Although FIGS. 2 and 3 contemplate that audio IC 9 resides in a personal audio device, systems and methods described herein may also be applied to electrical and electronic systems and devices other than a personal audio device, including audio systems for use in a computing device larger than a personal audio device, an automobile, a building, or other structure.

FIG. 4 illustrates a block and circuit diagram of selected components of an example switched mode amplifier 20, in accordance with embodiments of the present disclosure. In some embodiments, switched mode amplifier 20 may implement all or a portion of amplifier 16 described with respect to FIG. 3. As shown in FIG. 4, switched mode amplifier 20 may comprise a loop filter 22, a converter controller 24, and a power converter 26.

Loop filter 22 may comprise any system, device, or apparatus configured to receive an input signal (e.g., audio input signal Y_{IN} or a derivative thereof) and a feedback signal (e.g., audio output signal V_{OUT}, a derivative thereof, or other signal indicative of audio output signal V_{OUT}) and based on such input signal and feedback signal, generate a controller input signal to be communicated to converter controller 24. In some embodiments, such controller input signal may comprise a signal indicative of an integrated error between the input signal and the feedback signal. In other embodiments, such controller input signal may comprise a signal indicative of a target current signal to be driven as an output current I_{OUT} or a target voltage signal to be driven as an output voltage V_{OUT} to a load coupled to the output terminals of power converter 26.

Converter controller 24 may comprise any system, device, or apparatus configured to, based on the controller input signal, sequentially select among a plurality of switch configurations of power converter 26 and based on an input signal (e.g., input signal INPUT), output signal V_{OUT}, and/or other characteristics of switched mode amplifier 20, communicate a plurality of control signals to power converter 26 to apply a switch configuration from a plurality of switch configurations of switches of power converter 26 to selectively activate or deactivate each of the plurality of switches in order to transfer electrical energy from a power supply V_{SUPPLY} to the load of switched mode amplifier 20 in accordance with the input signal. Examples of switch configurations associated with each are described in greater detail elsewhere in this disclosure. In addition, in some embodiments, converter controller 24 may control switches of a power converter 26 in order to regulate a common mode voltage of the output terminals of power converter 26, as described in greater detail below.

Power converter 26 may receive a voltage V_{SUPPLY} (e.g., provided by power supply 10) at its input, and may generate at its output audio output signal V_{OUT}. Although not explicitly shown in FIG. 3, in some embodiments, voltage V_{SUPPLY} may be received via input terminals including a positive input terminal and a negative input terminal which may be coupled to a ground voltage. As described in greater detail in this disclosure, power converter 26 may comprise a power inductor and a plurality of switches that are controlled by control signals received from converter controller 24 in order to convert voltage V_{SUPPLY} to audio output signal V_{OUT}, such that audio output signal V_{OUT} is a function of the input signal to loop filter 22. Examples of power converter 26 are described in greater detail elsewhere in this disclosure.

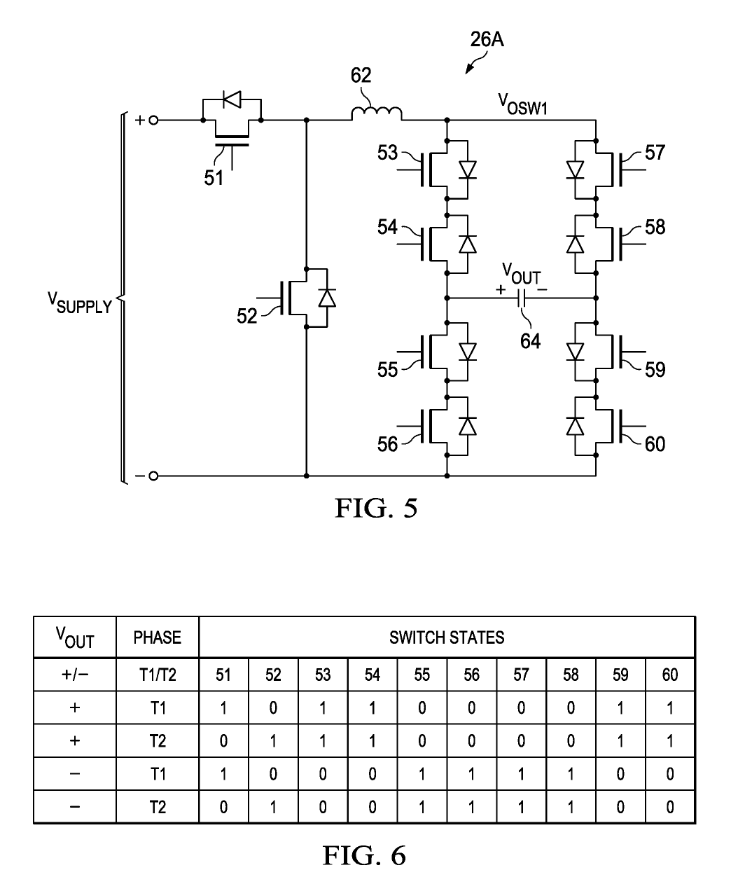

FIG. 5 illustrates a circuit diagram of selected components of an example power converter 26A, in accordance with embodiments of the present disclosure. In some embodiments, power converter 26A depicted in FIG. 5 may implement all or a portion of power converter 26 described with respect to FIG. 4. As shown in FIG. 5, power converter 26A may receive a voltage V_{SUPPLY} (e.g., provided by power supply 10) at input terminals, including a positive input terminal and a negative input terminal (which may in some embodiments be coupled to a ground voltage), and may generate at its output an output voltage V_{OUT}. Power converter 26A may comprise a power inductor 62 and plurality of switches 51-60. Power inductor 62 may comprise any passive two-terminal electrical component which resists changes in electrical current passing through it and such that when electrical current flowing through it changes, a time-varying magnetic field induces a voltage in power inductor 62, in accordance with Faraday's law of electromagnetic induction, which opposes the change in current that created the magnetic field.

Each switch 51-60 may comprise any suitable device, system, or apparatus for making a connection in an electric circuit when the switch is enabled (e.g., activated, closed, or on) and breaking the connection when the switch is disabled (e.g., deactivated, open, or off) in response to a control signal received by the switch. For purposes of clarity and exposition, control signals for switches 51-60 (e.g., control signals communicated from converter controller 24) are not depicted although such control signals would be present to selectively enable and disable switches 51-60. In some embodiments, a switch 51-60 may comprise an n-type metal-oxide-semiconductor field-effect transistor. Switch 51 may be coupled between a positive input terminal of the supply voltage V_{SUPPLY} and a first terminal of power inductor 62 such that an anode of a body diode of switch 51 is coupled to the first terminal of power inductor 62 and a cathode of the body diode of switch 51 is coupled to the positive input terminal of the supply voltage V_{SUPPLY}. Switch 52 may be coupled between a negative input terminal of the supply voltage V_{SUPPLY} and the first terminal of power inductor 62 such that a cathode of a body diode of switch 52 is coupled to the first terminal of power inductor 62 and an anode of the body diode of switch 52 is coupled to the negative input terminal of the supply voltage V_{SUPPLY}. Together, switch 51 and switch 52 may form a half bridge.

Switch 53 may be coupled between a second terminal of power inductor 62 and a terminal of switch 54. Switch 54 may be coupled between a first output terminal of power converter 26A and a terminal of switch 53. Switches 53 and 54 may be arranged such that their respective body diodes are coupled together via the respective cathodes of such respective body diodes. In some embodiments, switches 53 and 54 may be combined into a single switch.

Switch 55 may be coupled between the first output terminal of power converter 26A and a terminal of switch 56. Switch 56 may be coupled between the negative input terminal of the supply voltage V_{SUPPLY} and a terminal of switch 55. Switches 55 and 56 may be arranged such that their respective body diodes are coupled together via the respective cathodes of such respective body diodes. In some embodiments, switches 55 and 56 may be combined into a single switch.

Switch 57 may be coupled between the second terminal of power inductor 62 and a terminal of switch 58. Switch 58 may be coupled between a second output terminal of power converter 26A and a terminal of switch 57. Switches 57 and 58 may be arranged such that their respective body diodes are coupled together via the respective cathodes of such respective body diodes. In some embodiments, switches 57 and 58 may be combined into a single switch.

Switch 59 may be coupled between the second output terminal of power converter 26A and a terminal of switch 60. Switch 60 may be coupled between the negative input terminal of the supply voltage V_{SUPPLY} and a terminal of switch 59. Switches 59 and 60 may be arranged such that their respective body diodes are coupled together via the respective cathodes of such respective body diodes. In some embodiments, switches 59 and 60 may be combined into a single switch.

Together, switches 53-60 may comprise a full bridge having a first terminal coupled to the second terminal of power inductor 62 and a second terminal coupled to the second terminal of the supply voltage V_{SUPPLY}.

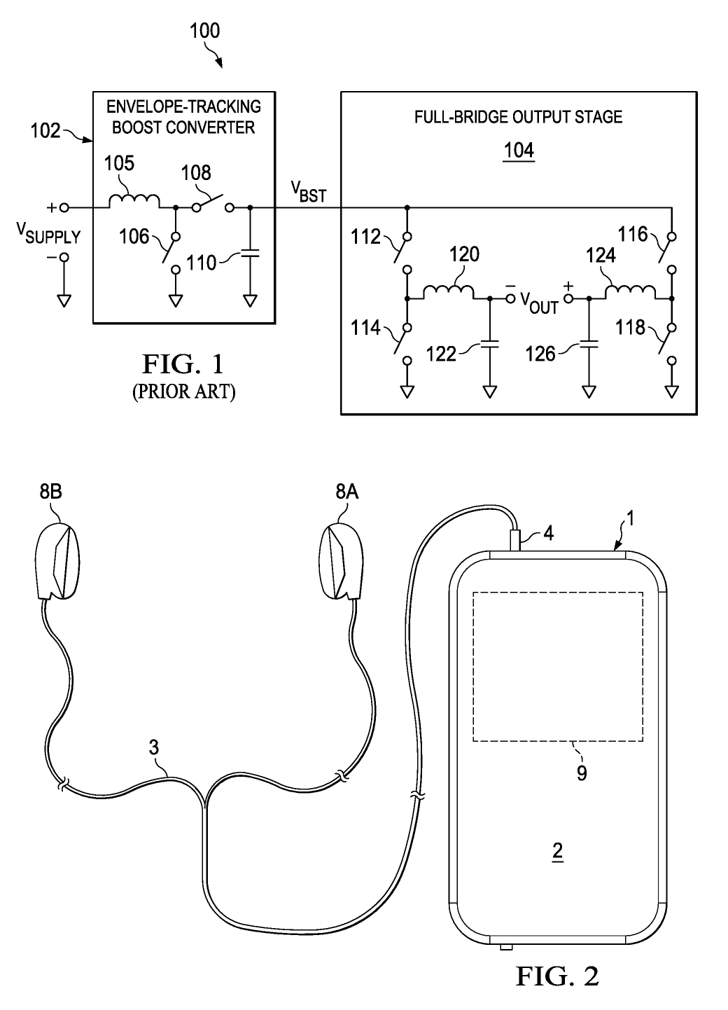

In addition to switches 51-60 and power inductor 62, power converter 26A may include an output capacitor 64 coupled between the first output terminal of power converter 26A and the second output terminal of power converter 26A. In order to generate a rectified audio signal at the terminal labeled with voltage V_{OSW1} in FIG. 5, switches 51 and 52 may switch at a switching frequency up to several megahertz while the full-bridge output stage comprising switches 53-60 may switch at an audio-band frequency (e.g., 20 Hz to 20 KHz) in order to rectify output voltage VOUT, resulting in a substantial reduction in switching loss as compared with full-bridge output stage 104 depicted in FIG. 1.

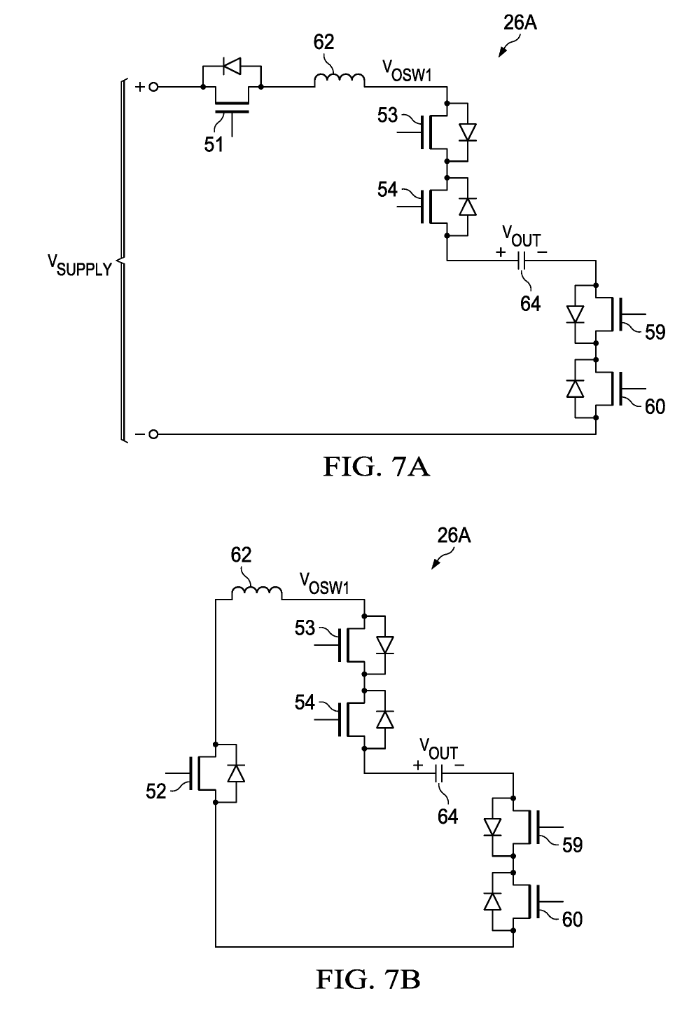

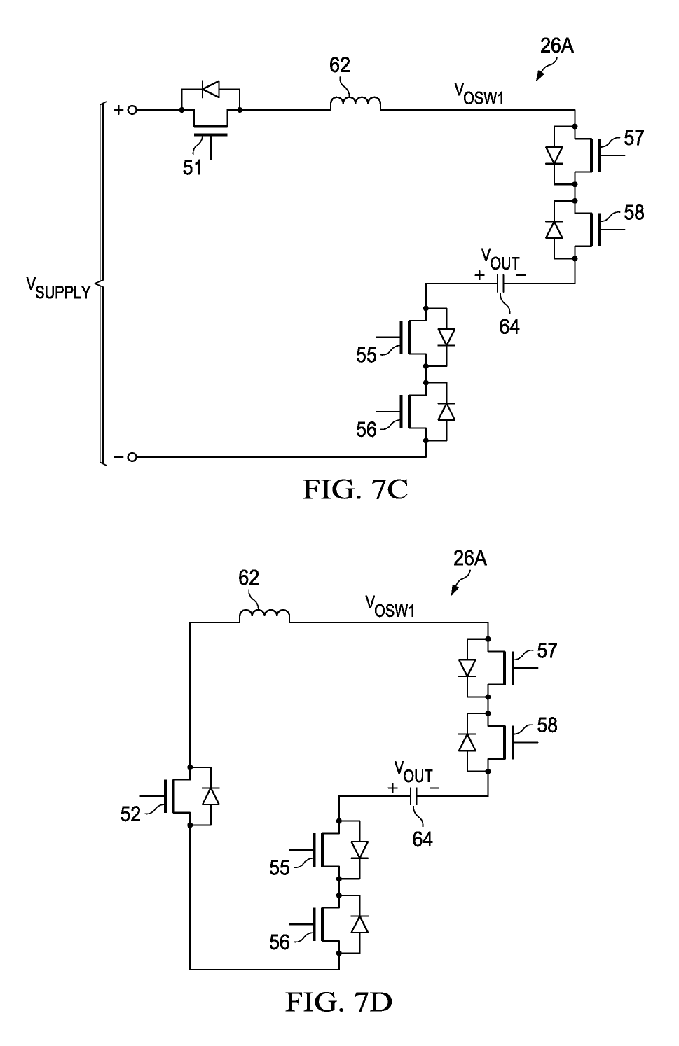

As described above, a power converter 26A may operate in a plurality of different switch configurations. FIG. 6 illustrates a table setting forth switch configurations of the power converter of FIG. 5 when operating in a buck mode, in accordance with embodiments of the present disclosure. Power converter 26A may operate in a buck mode when output voltage V_{OUT} has a magnitude lower than that for which the duration of a charging phase T1 becomes too small to operate power converter 26A in a boost mode (e.g., |V_{OUT}|<V_{SUPPLY}). As shown in FIG. 6, during a charging phase T1 of power converter 26A, when output voltage V_{OUT} is positive, converter controller 24 may enable switches 51, 53, 54, 59, and 60 of power converter 26A, with such switch configuration resulting in the equivalent circuit depicted in FIG. 7A (closed switches shown, open switches removed). During a discharge phase T2 of power converter 26A, when output voltage V_{OUT} is positive, converter controller 24 may enable switches 52, 53, 54, 59, and 60 of power converter 26A, with such switch configuration resulting in the equivalent circuit depicted in FIG. 7B (closed switches shown, open switches removed). Similarly, during a charging phase T1 of power converter 26A, when output voltage V_{OUT} is negative, converter controller 24 may enable switches 51, 55, 56, 57, and 58 of power converter 26A, with such switch configuration resulting in the equivalent circuit depicted in FIG. 7C (closed switches shown, open switches removed). During a discharge phase T2 of power converter 26A, when output voltage V_{OUT} is negative, converter controller 24 may enable switches 52, 55, 56, 57, and 58 of power converter 26A, with such switch configuration resulting in the equivalent circuit depicted in FIG. 7D (closed switches shown, open switches removed).

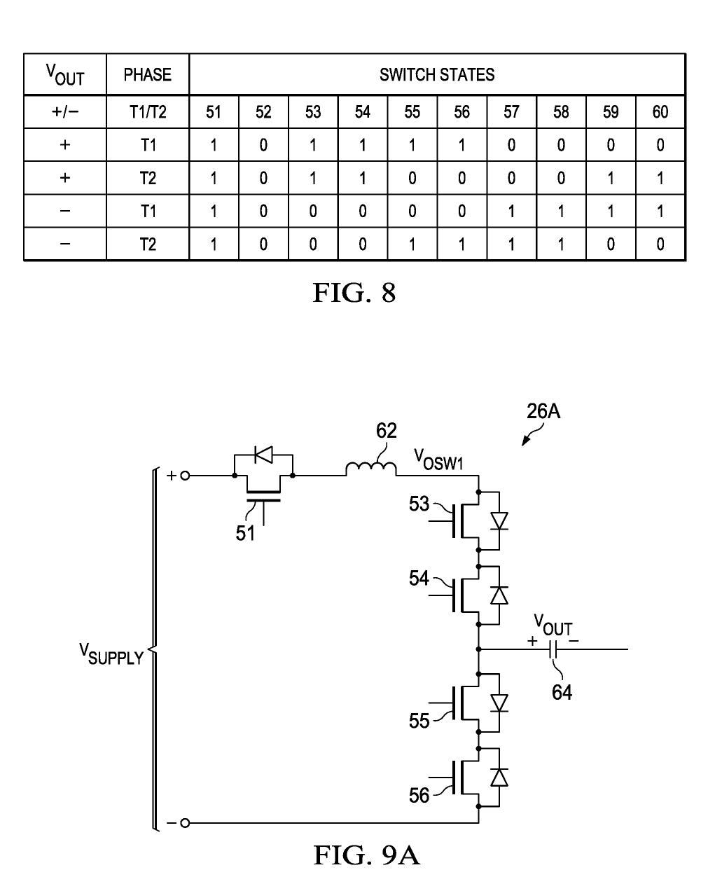

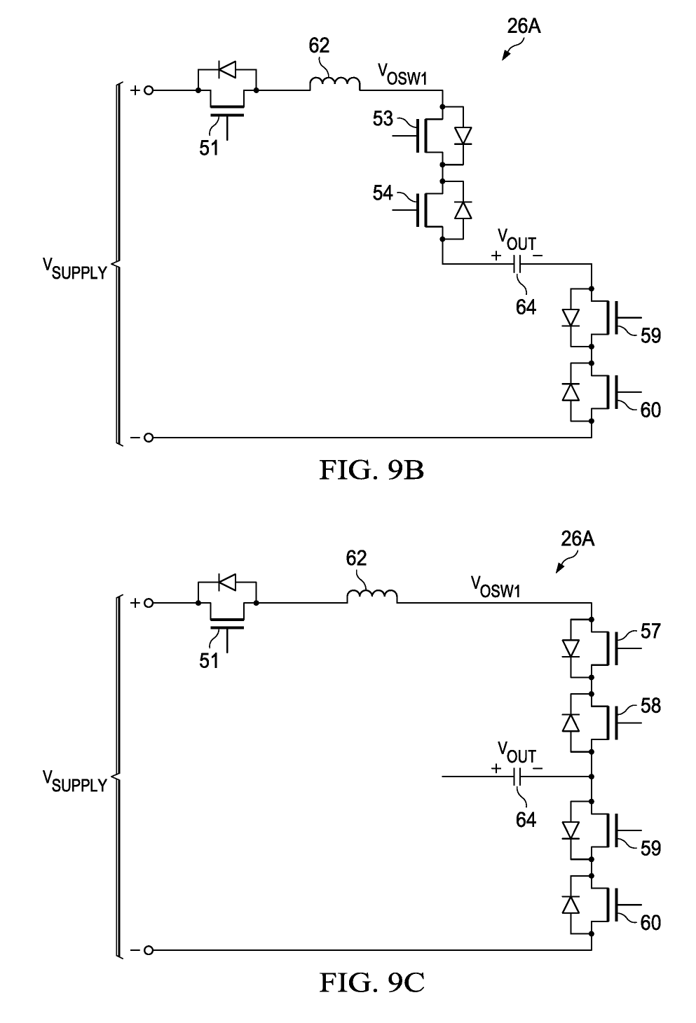

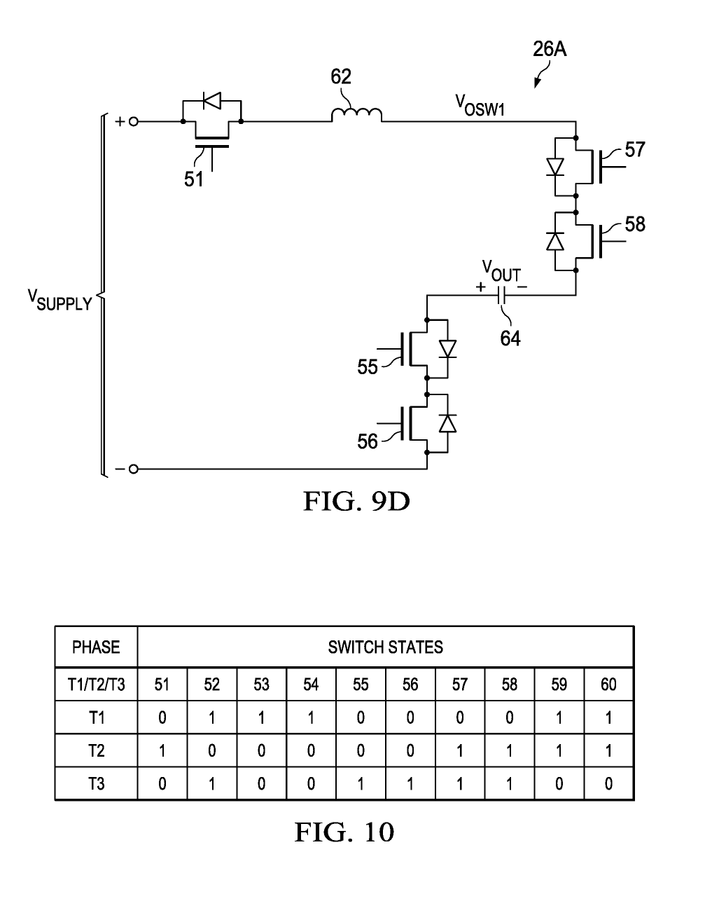

FIG. 8 illustrates a switch timing table setting forth switch configurations of the power converter of FIG. 5 when operating in a boost mode, in accordance with embodiments of the present disclosure. In accordance with the switch timing table of FIG. 8, switches 51 and 52 may switch at a switching frequency of several megahertz, while switches 53-60 may switch at an audio band frequency of approximately 20 Hz to 20 KHz. Power converter 26A may operate in a boost mode when output voltage V_{OUT} has a magnitude higher than that for which the duration of a charging phase T1 becomes too large to operate power converter 26A in a buck mode (e.g., |V_{OUT}|>V_{SUPPLY}). As shown in FIG. 8, during a charging phase T1 of power converter 26A, when output voltage V_{OUT} is positive, converter controller 24 may enable switches 51, 53, 54, 55, and 56 of power converter 26A, with such switch configuration resulting in the equivalent circuit depicted in FIG. 9A (closed switches shown, open switches removed). During a discharge phase T2 of power converter 26A, when output voltage V_{OUT} is positive, converter controller 24 may enable switches 51, 53, 54, 59, and 60 of power converter 26A, with such switch configuration resulting in the equivalent circuit depicted in FIG. 9B (closed switches shown, open switches removed). Similarly, during a charging phase T1 of power converter 26A, when output voltage V_{OUT} is negative, converter controller 24 may enable switches 51, 57, 58, 59, and 60 of power converter 26A, with such switch configuration resulting in the equivalent circuit depicted in FIG. 9C (closed switches shown, open switches removed). During a discharge phase T2 of power converter 26A, when output voltage V_{OUT} is negative, converter controller 24 may enable switches 51, 55, 56, 57, and 58 of power converter 26A, with such switch configuration resulting in the equivalent circuit depicted in FIG. 9D (closed switches shown, open switches removed).

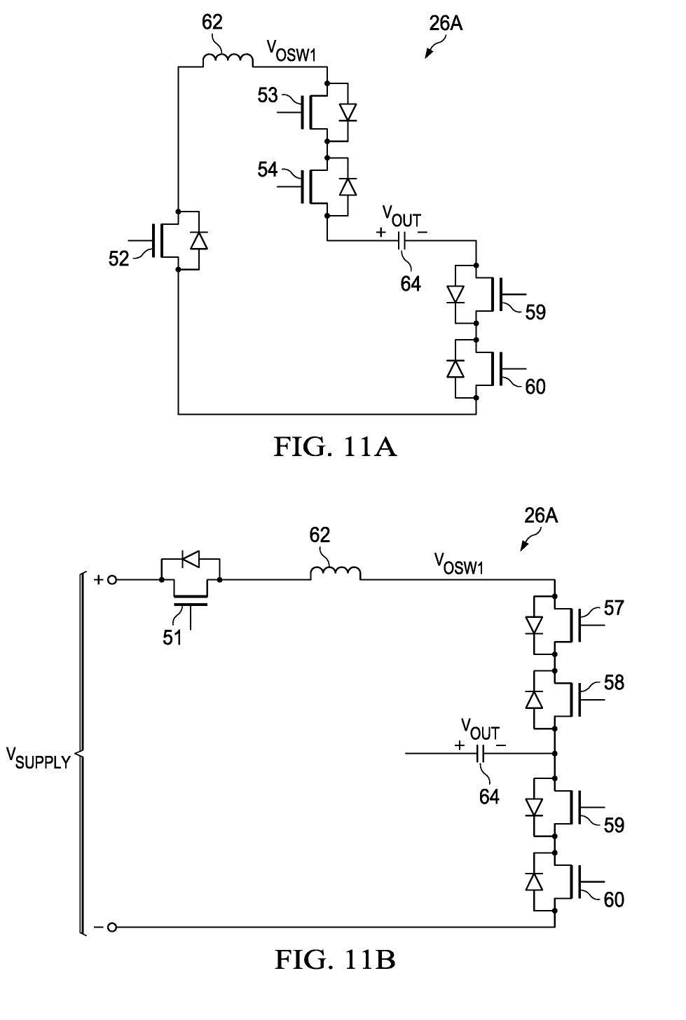

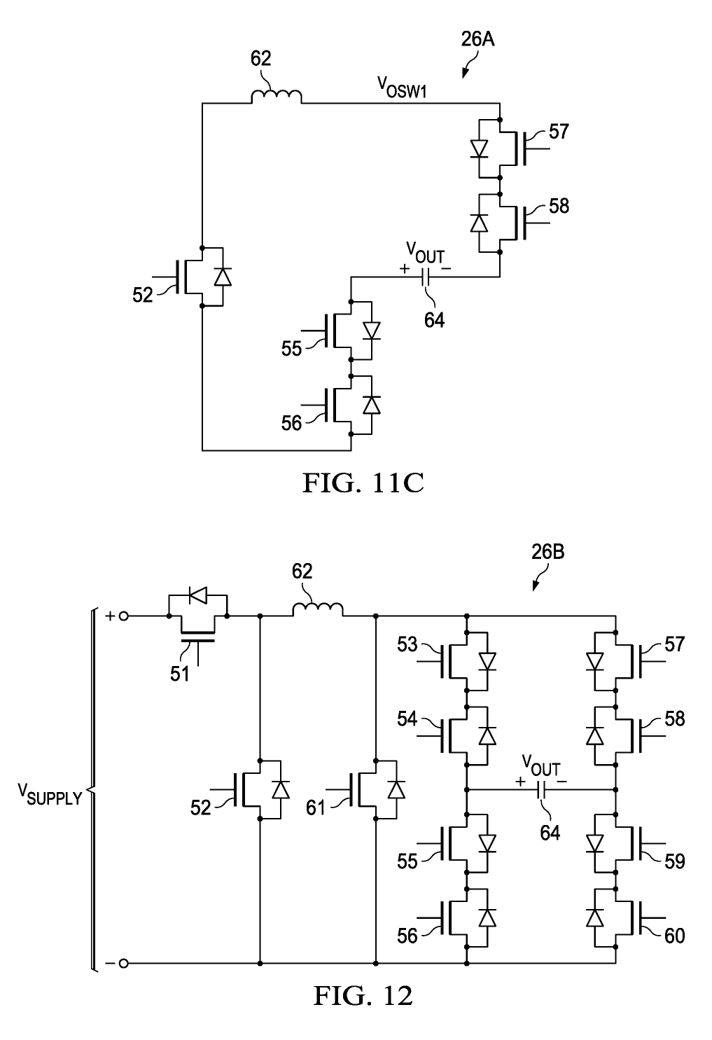

FIG. 10 illustrates a switch timing table setting forth switch configurations of the power converter of FIG. 5 when operating in a differential buck-boost mode, in accordance with embodiments of the present disclosure. In accordance with the switch timing table of FIG. 10, switches 51 and 52 may switch at a switching frequency of several megahertz, while switches 53-60 may switch at an audio band frequency of approximately 20 Hz to 20 KHz. Power converter 26A may operate in the differential buck-boost mode for very low magnitudes (e.g., |V_{OUT}|≈0). As shown in FIG. 10, during a first phase T1 of power converter 26A, converter controller 24 may enable switches 52, 53, 54, 59, and 60 of power converter 26A, with such switch configuration resulting in the equivalent circuit depicted in FIG. 11A (closed switches shown, open switches removed). During a second phase T2 of power converter 26A, converter controller 24 may enable switches 51, 57, 58, 59, and 60 of power converter 26A, with such switch configuration resulting in the equivalent circuit depicted in FIG. 11B (closed switches shown, open switches removed). During a third phase T3 of power converter 26A, converter controller 24 may enable switches 52, 55, 56, 57, and 58 of power converter 26A, with such switch configuration resulting in the equivalent circuit depicted in FIG. 11C (closed switches shown, open switches removed). Accordingly, output voltage V_{OUT} may be regulated by adjusting an on-time difference between phases T1 and T3, including regulating at a voltage of zero when the on-times of phases T1 and T3 are the same.

FIG. 12 illustrates a circuit diagram of selected components of another example power converter 26B, in accordance with embodiments of the present disclosure. In some embodiments, power converter 26B depicted in FIG. 12 may implement all or a portion of power converter 26 described with respect to FIG. 4. Power converter 26B depicted in FIG. 12 may in many respects be identical to power converter 26A of FIG. 5, and thus only the differences between power converter 26B and power converter 26A are discussed. The main difference between power converter 26B and power converter 26A is that power converter 26B includes another switch 61 coupled between the second terminal of power inductor 62 and the second terminal of supply voltage V_{SUPPLY}. In addition, switch 61 may be arranged such that an anode of its body diode is coupled to the second terminal of supply voltage V_{SUPPLY} and a diode of its body diode is coupled to the second terminal of power inductor 62. Switch 61 may be enabled at certain times (e.g., when switches 53, 54, 55, and 56 are enabled or when switches 57, 58, 59, and 60 are enabled, so as to reduce a conduction resistance to minimize power loss in either of the boost mode or buck mode.

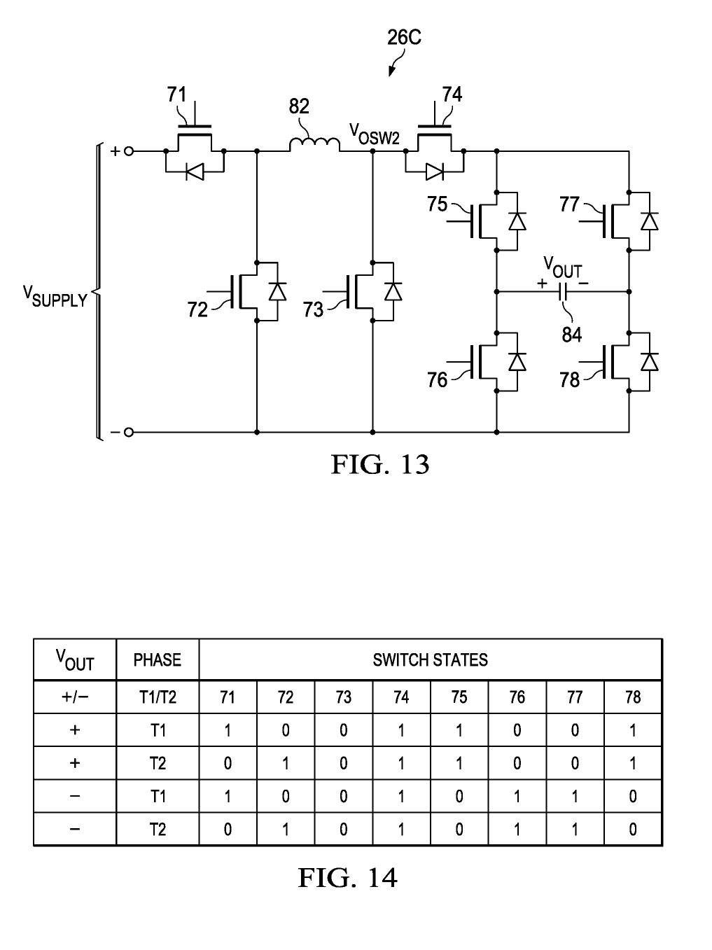

FIG. 13 illustrates a circuit diagram of selected components of another example power converter 26C, in accordance with embodiments of the present disclosure. In some embodiments, power converter 26C depicted in FIG. 13 may implement all or a portion of power converter 26 described with respect to FIG. 4. As shown in FIG. 13, power converter 26C may receive a voltage V_{SUPPLY} (e.g., provided by power supply 10) at input terminals, including a positive input terminal and a negative input terminal (which may in some embodiments be coupled to a ground voltage), and may generate at its output an output voltage V_{OUT}. Power converter 26C may comprise a power inductor 82 and plurality of switches 71-78. Power inductor 82 may comprise any passive two-terminal electrical component which resists changes in electrical current passing through it and such that when electrical current flowing through it changes, a time-varying magnetic field induces a voltage in power inductor 82, in accordance with Faraday's law of electromagnetic induction, which opposes the change in current that created the magnetic field.

Each switch 71-78 may comprise any suitable device, system, or apparatus for making a connection in an electric circuit when the switch is enabled (e.g., activated, closed, or on) and breaking the connection when the switch is disabled (e.g., deactivated, open, or off) in response to a control signal received by the switch. For purposes of clarity and exposition, control signals for switches 71-78 (e.g., control signals communicated from converter controller 24) are not depicted although such control signals would be present to selectively enable and disable switches 71-78. In some embodiments, a switch 71-78 may comprise an n-type metal-oxide-semiconductor field-effect transistor. Switch 71 may be coupled between a positive input terminal of the supply voltage V_{SUPPLY} and a first terminal of power inductor 82 such that an anode of a body diode of switch 71 is coupled to the first terminal of power inductor 82 and a cathode of the body diode of switch 71 is coupled to the positive input terminal of the supply voltage V_{SUPPLY}. Switch 72 may be coupled between a negative input terminal of the supply voltage V_{SUPPLY} and the first terminal of power inductor 72 such that a cathode of a body diode of switch 72 is coupled to the first terminal of power inductor 72 and an anode of the body diode of switch 72 is coupled to the negative input terminal of the supply voltage V_{SUPPLY}. Together, switch 71 and switch 72 may form a half bridge.

Switch 73 may be coupled between the second terminal of power inductor 82 and the second terminal of supply voltage V_{SUPPLY}. In addition, switch 73 may be arranged such that an anode of its body diode is coupled to the second terminal of supply voltage V_{SUPPLY} and a diode of its body diode is coupled to the second terminal of power inductor 82.

Switch 74 may be coupled between the second terminal of power inductor 82 and terminals of switches 75 and 77. In addition, switch 74 may be arranged such that an anode of its body diode is coupled to the second terminal of power inductor 82 and a cathode of its body diode is coupled to terminals of switches 75 and 77.

Switch 75 may be coupled between a terminal of switch 74 and a first output terminal of power converter 26C. In addition, switch 75 may be arranged such that an anode of its body diode is coupled to the first output terminal of power converter 26C and a cathode of its body diode is coupled to terminals of switches 74 and 77.

Switch 76 may be coupled between the second terminal of supply voltage V_{SUPPLY} and the first output terminal of power converter 26C. In addition, switch 76 may be arranged such that an anode of its body diode is coupled to the second terminal of supply voltage V_{SUPPLY} and a cathode of its body diode is coupled to the first output terminal of power converter 26C.

Switch 77 may be coupled between a terminal of switch 74 and a second output terminal of power converter 26C. In addition, switch 77 may be arranged such that an anode of its body diode is coupled to the second output terminal of power converter 26C and a cathode of its body diode is coupled to terminals of switches 74 and 75.

Switch 78 may be coupled between the second terminal of supply voltage V_{SUPPLY} and the second output terminal of power converter 26C. In addition, switch 78 may be arranged such that an anode of its body diode is coupled to the second terminal of supply voltage V_{SUPPLY} and a cathode of its body diode is coupled to the second output terminal of power converter 26C.

Together, switches 75-78 may comprise a full bridge having a first terminal coupled to the second terminal of power inductor 82 via switch 74 and a second terminal coupled to the second terminal of the supply voltage V_{SUPPLY}.

In addition to switches 71-78 and power inductor 82, power converter 26C may include an output capacitor 84 coupled between the first output terminal of power converter 26C and the second output terminal of power converter 26C. In order to generate a rectified audio signal at the terminal labeled with voltage V_{OSW2} in FIG. 13, switches 71-74 may switch at a switching frequency up to several megahertz while the full-bridge output stage comprising switches 53-60 may switch at an audio-band frequency (e.g., 20 Hz to 20 KHz) in order to rectify output voltage VOUT, resulting in a substantial reduction in switching loss as compared with full-bridge output stage 104 depicted in FIG. 1.

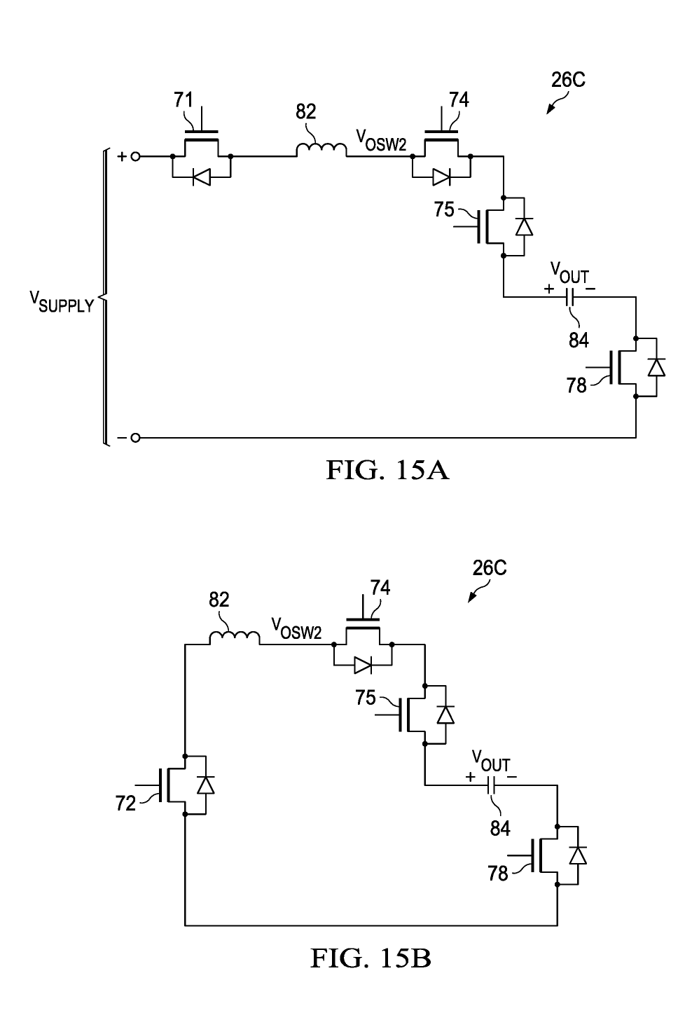

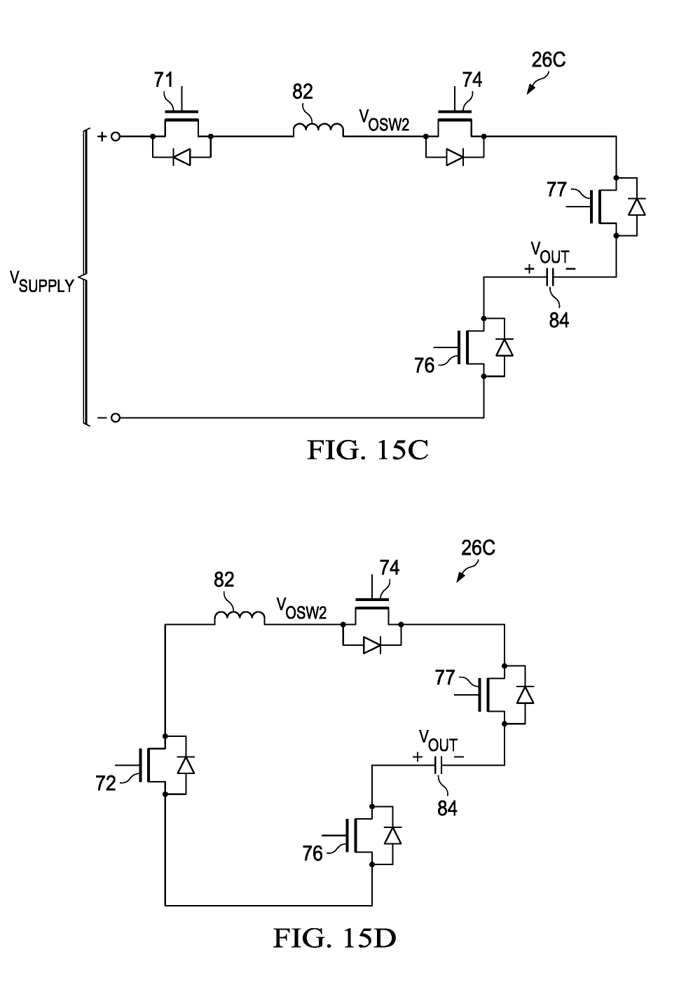

As described above, a power converter 26C may operate in a plurality of different switch configurations. FIG. 14 illustrates a switch table setting forth switch configurations of the power converter of FIG. 13 when operating in a buck mode, in accordance with embodiments of the present disclosure. Power converter 26C may operate in a buck mode when output voltage V_{OUT} has a magnitude lower than that for which the duration of a charging phase T1 becomes too small to operate power converter 26C in a boost mode (e.g., |V_{OUT}|<V_{SUPPLY}). As shown in FIG. 14, during a charging phase T1 of power converter 26C, when output voltage V_{OUT} is positive, converter controller 24 may enable switches 71, 74, 75, and 78 of power converter 26C, with such switch configuration resulting in the equivalent circuit depicted in FIG. 15A (closed switches shown, open switches removed). During a discharge phase T2 of power converter 26C, when output voltage V_{OUT} is positive, converter controller 24 may enable switches 72, 74, 75, and 78, of power converter 26C, with such switch configuration resulting in the equivalent circuit depicted in FIG. 15B (closed switches shown, open switches removed). Similarly, during a charging phase T1 of power converter 26C, when output voltage V_{OUT} is negative, converter controller 24 may enable switches 71, 74, 76, and 77 of power converter 26C, with such switch configuration resulting in the equivalent circuit depicted in FIG. 15C (closed switches shown, open switches removed). During a discharge phase T2 of power converter 26C, when output voltage V_{OUT} is negative, converter controller 24 may enable switches 72, 74, 76, and 77 of power converter 26C, with such switch configuration resulting in the equivalent circuit depicted in FIG. 15D (closed switches shown, open switches removed).

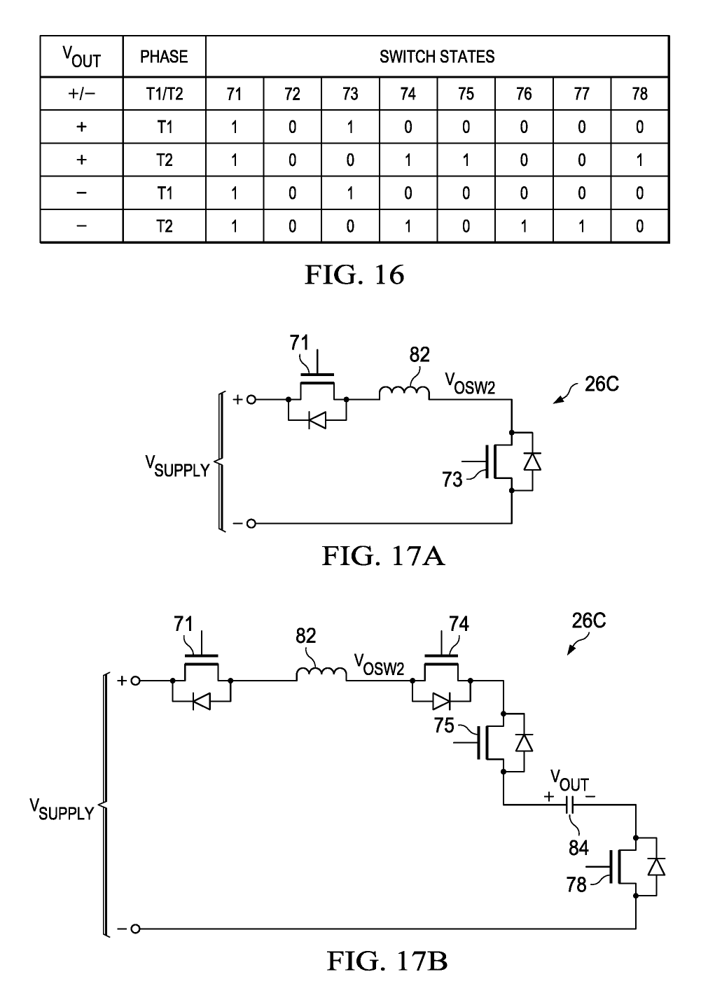

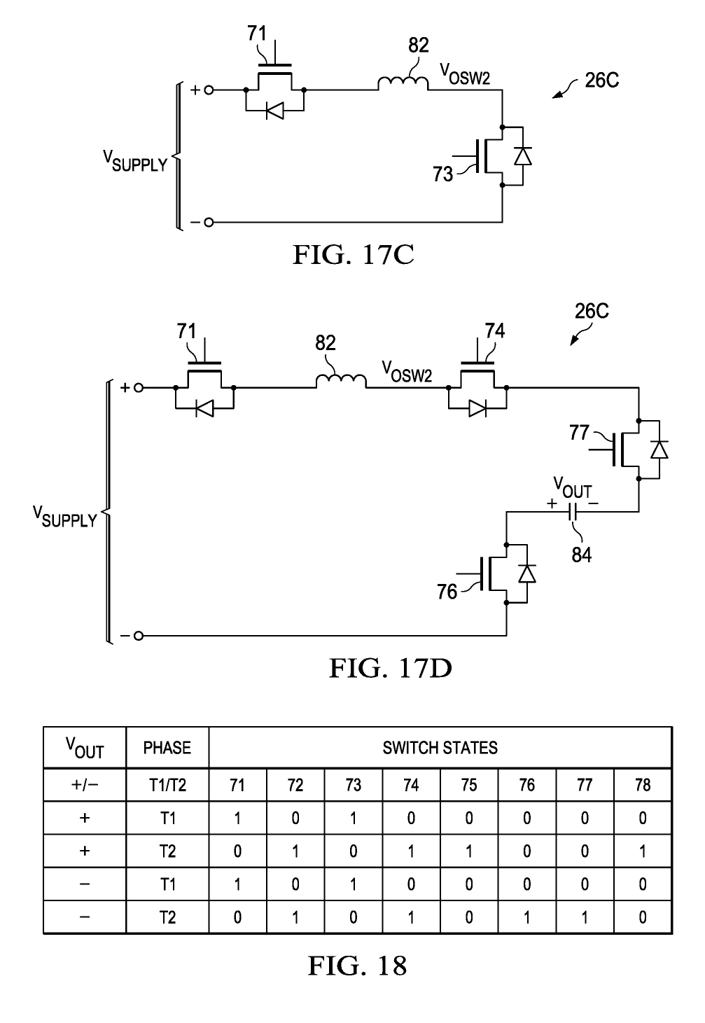

FIG. 16 illustrates a switching timing table setting forth switch configurations of the power converter of FIG. 13 when operating in a boost mode, in accordance with embodiments of the present disclosure. Power converter 26C may operate in a buck mode when output voltage V_{OUT} has a magnitude lower than that for which the duration of a charging phase T1 becomes too large to operate power converter 26C in a buck mode (e.g., |V_{OUT}|>V_{SUPPLY}). As shown in FIG. 16, during a charging phase T1 of power converter 26C, when output voltage V_{OUT} is positive, converter controller 24 may enable switches 71 and 73 of power converter 26C, with such switch configuration resulting in the equivalent circuit depicted in FIG. 17A (closed switches shown, open switches removed). During a discharge phase T2 of power converter 26C, when output voltage V_{OUT} is positive, converter controller 24 may enable switches 71, 74, 75, and 78, of power converter 26C, with such switch configuration resulting in the equivalent circuit depicted in FIG. 17B (closed switches shown, open switches removed). Similarly, during a charging phase T1 of power converter 26C, when output voltage V_{OUT} is negative, converter controller 24 may enable switches 71 and 73 of power converter 26C, with such switch configuration resulting in the equivalent circuit depicted in FIG. 17C (closed switches shown, open switches removed). During a discharge phase T2 of power converter 26C, when output voltage V_{OUT} is negative, converter controller 24 may enable switches 71, 74, 76, and 77 of power converter 26C, with such switch configuration resulting in the equivalent circuit depicted in FIG. 17D (closed switches shown, open switches removed).

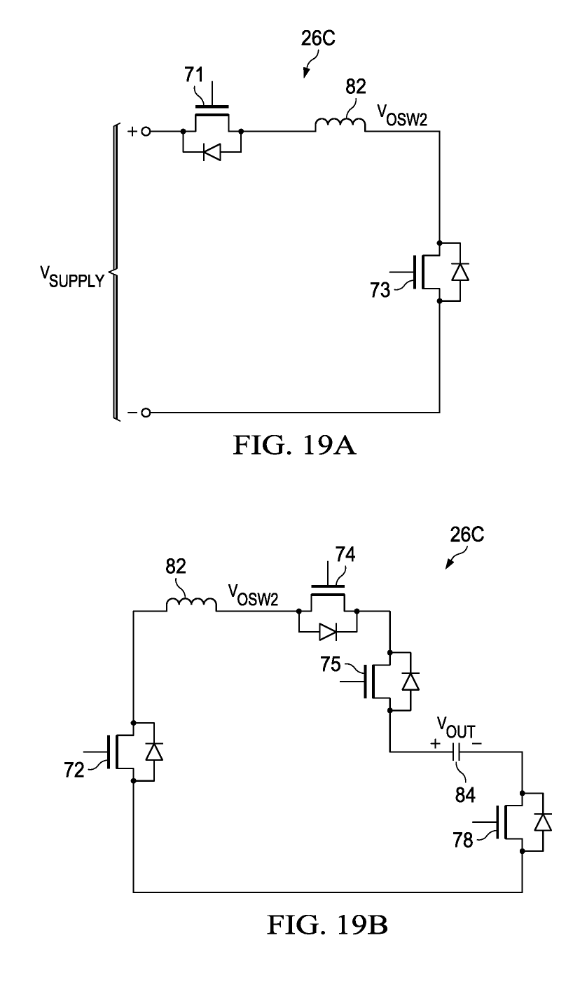

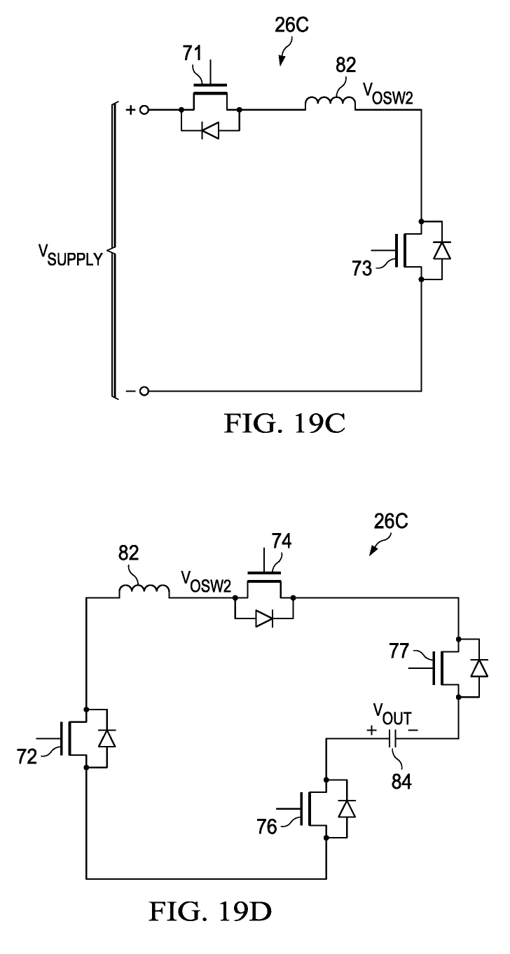

FIG. 18 illustrates a switching timing table setting forth switch configurations of the power converter of FIG. 13 when operating in a buck-boost mode, in accordance with embodiments of the present disclosure. As shown in FIG. 18, during a charging phase T1 of power converter 26C, when output voltage V_{OUT} is positive, converter controller 24 may enable switches 71 and 73 of power converter 26C, with such switch configuration resulting in the equivalent circuit depicted in FIG. 19A (closed switches shown, open switches removed). During a discharge phase T2 of power converter 26C, when output voltage V_{OUT} is positive, converter controller 24 may enable switches 72, 74, 75, and 78, of power converter 26C, with such switch configuration resulting in the equivalent circuit depicted in FIG. 19B (closed switches shown, open switches removed). Similarly, during a charging phase T1 of power converter 26C, when output voltage V_{OUT} is negative, converter controller 24 may enable switches 71 and 73 of power converter 26C, with such switch configuration resulting in the equivalent circuit depicted in FIG. 19C (closed switches shown, open switches removed). During a discharge phase T2 of power converter 26C, when output voltage V_{OUT} is negative, converter controller 24 may enable switches 72, 74, 76, and 77 of power converter 26C, with such switch configuration resulting in the equivalent circuit depicted in FIG. 19D (closed switches shown, open switches removed).

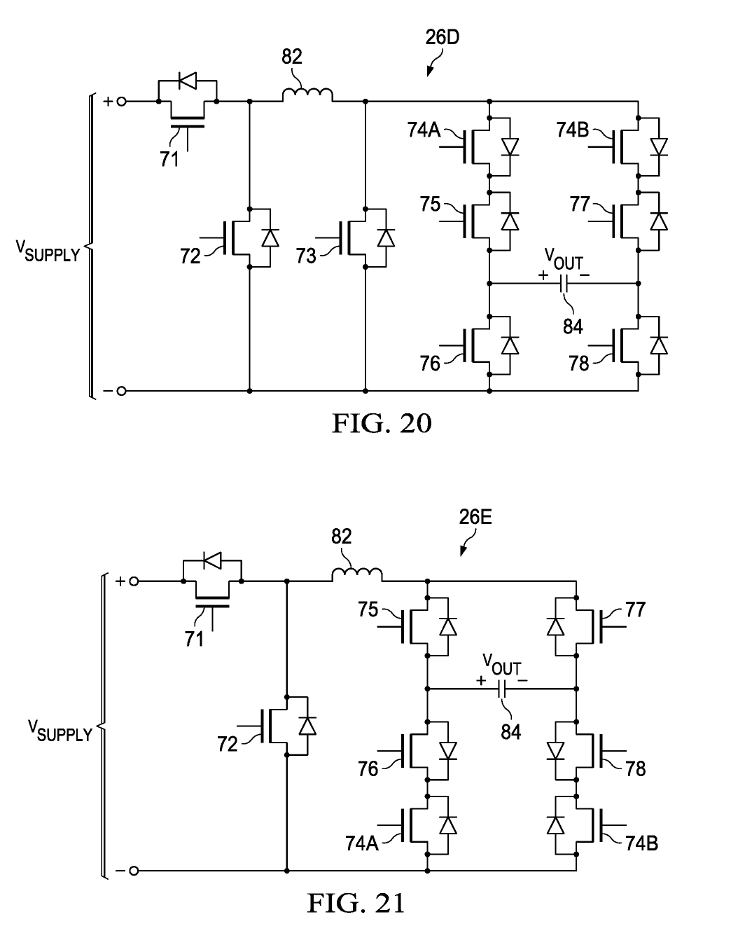

FIG. 20 illustrates a circuit diagram of selected components of another example power converter 26D, in accordance with embodiments of the present disclosure. In some embodiments, power converter 26D depicted in FIG. 20 may implement all or a portion of power converter 26 described with respect to FIG. 4. Power converter 26D depicted in FIG. 20 may in many respects be identical to power converter 26C of FIG. 13, and thus only the differences between power converter 26D and power converter 26C are discussed. The main differences between power converter 26D and power converter 26C are that:

(a) switch 74 present in power converter 26C is not present in power converter 26D and is replaced with a short;

(b) switch 74A is added in series with switch 75; and

(c) switch 74B is added in series with switch 77.

Power converter 26D may have the same operating modes as described above with respect to power converter 26C. When output voltage V_{OUT} is positive, switch 74A may have the same function as and operate like switch 74 of power converter 26C and switch 74B may be disabled. When output voltage V_{OUT} is negative, switch 74B may have the same function as and operate like switch 74 of power converter 26C and switch 74A may be disabled.

FIG. 21 illustrates a circuit diagram of selected components of another example power converter 26E, in accordance with embodiments of the present disclosure. In some embodiments, power converter 26E depicted in FIG. 21 may implement all or a portion of power converter 26 described with respect to FIG. 4. Power converter 26E depicted in FIG. 21 may in many respects be identical to power converter 26C of FIG. 13, and thus only the differences between power converter 26E and power converter 26C are discussed. The main differences between power converter 26E and power converter 26C are that:

(a) switch 73 present in power converter 26C is not present in power converter 26D and is replaced with an open;

(b) switch 74 present in power converter 26C is not present in power converter 26D and is replaced with a short;

(c) switch 74A is added in series with switch 76; and

(d) switch 74B is added in series with switch 78.

Power converter 26E may have the same operating modes as power converter 26D, but with fewer components.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. A multi-mode switching power converter comprising:
a power inductor;
a first switch coupled between a first terminal of the power inductor and a first supply terminal having a first voltage;
a second switch coupled between the first terminal of the power inductor and a second supply terminal having a second voltage;
a full bridge comprising a plurality of switches and having an output for producing an output voltage comprising a first output terminal and a second output terminal, wherein a first input of the full bridge is coupled to a second terminal of the power inductor and a second input of the full bridge is coupled to one of the first supply terminal and the second supply terminal; and
a capacitor coupled between the first output terminal and the second output terminal.

2. The multi-mode switching power converter of claim 1, wherein the first switch, the second switch, and the plurality of switches are arranged to sequentially operate in a plurality of switch configurations in accordance with a selected operational mode of the power converter, the selected operational mode selected from a plurality of operational modes.

3. The multi-mode switching power converter of claim 2, wherein the plurality of operational modes comprises a buck mode wherein the multi-mode switching power converter operates as a buck converter and a boost mode wherein the multi-mode switching power converter operates as a boost converter.

4. The multi-mode switching power converter of claim 1, wherein the second terminal of the power inductor is directly coupled by a first direct connection to the first input of the full bridge and is directly coupled by a second direct connection to the second input of the full bridge.

5. The multi-mode switching power converter of claim 1, wherein the second terminal of the power inductor is coupled via a third switch to the first input of the full bridge and is coupled via a fourth switch to the second input of the full bridge.

6. The multi-mode switching power converter of claim 1, wherein the first switch and the second switch are each half-bridge switches.

7. A method comprising, in a multi-mode switching power converter comprising a power inductor, a first switch coupled between a first terminal of the power inductor and a first supply terminal having a first voltage, a second switch coupled between the first terminal of the power inductor and a second supply terminal having a second voltage, a full bridge comprising a plurality of switches and having an output for producing an output voltage comprising a first output terminal and a second output terminal, wherein a first input of the full bridge is coupled to a second terminal of the power inductor and a second input of the full bridge is coupled to one of the first supply terminal and the second supply terminal, and a capacitor coupled between the first output terminal and the second output terminal, sequentially operating the first switch, the second switch, and the plurality of switches in a plurality of switch configurations in accordance with a selected operational mode of the power converter, the selected operational mode selected from a plurality of operational modes.

8. The method of claim 7, wherein the plurality of operational modes comprises a buck mode wherein the multi-mode switching power converter operates as a buck converter and a boost mode wherein the multi-mode switching power converter operates as a boost converter.

9. The method of claim 7, wherein the second terminal of the power inductor is directly coupled by a first direct connection to the first input of the full bridge and is directly coupled by a second direct connection to the second input of the full bridge.

10. The method of claim 7, wherein the second terminal of the power inductor is coupled via a third switch to the first input of the full bridge and is coupled via a fourth switch to the second input of the full bridge.

11. The method of claim 7, wherein the first switch and the second switch are each half-bridge switches.

12. A switching power stage for producing an output voltage to a load, comprising:
a multi-mode switching power converter comprising:
a power inductor;
a first switch coupled between a first terminal of the power inductor and a first supply terminal having a first voltage;
a second switch coupled between the first terminal of the power inductor and a second supply terminal having a second voltage;
a full bridge comprising a plurality of switches and having an output for producing an output voltage comprising a first output terminal and a second output terminal, wherein a first input of the full bridge is coupled to a second terminal of the power inductor and a second input of the full bridge is coupled to one of the first supply terminal and the second supply terminal; and
a capacitor coupled between the first output terminal and the second output terminal; and
a controller configured to sequentially operate the first switch, the second switch, and the plurality of switches in a plurality of switch configurations in accordance with a selected operational mode of the power converter, the selected operational mode selected from a plurality of operational modes.

13. The switching power stage of claim 12, wherein the plurality of operational modes comprises a buck mode wherein the multi-mode switching power converter operates as a buck converter and a boost mode wherein the multi-mode switching power converter operates as a boost converter.

14. The switching power stage of claim 12, wherein the second terminal of the power inductor is directly coupled by a first direct connection to the first input of the full bridge and is directly coupled by a second direct connection to the second input of the full bridge.

15. The switching power stage of claim 12, wherein the second terminal of the power inductor is coupled via a third switch to the first input of the full bridge and is coupled via a fourth switch to the second input of the full bridge.

16. The switching power stage of claim 12, wherein the first switch and the second switch are each half-bridge switches.
